(19) United States
(12) Patent Application Publication
(10) Pub. No.: US 2026/0001793 A1
(43) Pub. Date: Jan. 1, 2026

(54) WASTEWATER TREATMENT METHOD AND WASTEWATER TREATMENT APPARATUS

(71) Applicant: ORGANO CORPORATION, Tokyo (JP)

(72) Inventors: Taichi YAMAMOTO, Tokyo (JP); Hironori YUI, Tokyo (JP); Yoshiaki HASEBE, Tokyo (JP)

(73) Assignee: ORGANO CORPORATION, Tokyo (JP)

(21) Appl. No.: 19/105,457

(22) PCT Filed: Jul. 20, 2023
(86) PCT No.: PCT/JP2023/026623

§ 371 Date: Feb. 21, 2025

(30) Foreign Application Priority Data
Sep. 1, 2022 (JP) 2022-138926

(51) Int. Cl. C02F 3/00; C02F 3/10; C02F 101/30; C02F 103/34; C02F 103/40

(52) U.S. Cl. CPC C02F 3/006; C02F 3/108; C02F 2101/30; C02F 2103/346; C02F 2103/40; C02F 2209/245; C02F 2209/38; C02F 2305/06

(57) ABSTRACT

A wastewater treatment apparatus included: a reaction tank which performs biological treatment of raw water, which is organic wastewater; an adding device that adds a nutrient substance to the raw water; a meter that measures the concentration of at least a volatile organic compound in gas released from water in the reaction tank; and a control device for controlling an additive amount of the nutrient substance by the adding device based on a measured value of the concentration obtained by the meter.

### TECHNICAL FIELD

The present invention relates to a wastewater treatment method and a wastewater treatment apparatus for treating organic wastewater by biological treatment.

### BACKGROUND ART

Biological treatment using microorganisms is generally used as wastewater treatment performed before discharging wastewater containing organic matter, i.e., organic wastewater, into the environment. In biological treatment, environmental conditions such as water temperature and pH must be optimized and nutrient substances such as nitrogen, phosphorus, and trace metals need to be added in order to maintain high decomposition activity of organic matter by microorganisms. Compared to wastewater from public sewage systems into where domestic wastewater flows, the nutritive substances are likely to be insufficient in the wastewater from factories. In particular, in the wastewater from chemical plants and semiconductor manufacturing plants, shortage of the nutritive substances required for biological treatment is remarkable.

It is recommended that the amount of nutrient substances added to raw water, which is organic wastewater, is proportional to the concentration of organic matter in the raw water. Assuming that the concentration of organic matter in the raw water is expressed by biochemical oxygen demand (BOD) concentration, the preferred additive amount of nitrogen (N) and phosphorus (P) as nutrient substances in wastewater treatment by aerobic microorganisms, i.e., aerobic treatment, is, for example, BOD:N:P=100:5:1, in terms of mass. Although it is difficult to perform the BOD concentration measurement of the raw water on-line or in a short time, total organic carbon (TOC) concentration in water can be measured on-line. Therefore, for example, Patent Literature 1 discloses that the correlation between the TOC concentration and the BOD concentration in the raw water is obtained in advance, and the TOC concentration of the raw water is monitored by an on-line TOC concentration meter and converted into a BOD concentration value, and then the additive amount of nitrogen and phosphorus added is controlled based on the obtained BOD concentration value.

When a volatile organic compound (VOC) is contained in raw water, which is organic wastewater, or when a volatile organic compound is generated as an intermediary metabolite in the process of biological treatment of organic wastewater, the volatile organic compound in the water may be transferred to the gas phase by aeration or the like depending on the biological treatment conditions. Since volatile organic compounds are also air pollutants, their emission into the atmosphere must be reduced as much as possible, and if the emission of volatile organic compounds is high, it is necessary to install exhaust gas treatment equipment. When optimizing the additive amount of nutrient substances in biological treatment, the reduction of volatile organic compound emissions should also be considered.

When aerobic treatment is performed by biological treatment, the BOD volume loading in a wastewater treatment apparatus can be increased by using carriers in the reaction tank, but it is known in this case that the amount of surplus sludge generated increases. Patent Literature 2 discloses that, as a technique to suppress the generation of surplus sludge without reducing the BOD removal rate, control is performed so that the concentration of soluble phosphorus in the reaction tank is maintained at 0.5 mg/L or lower, and the concentration of soluble nitrogen in the reaction tank is maintained at 3 mg/L or higher.

### CITATION LIST

### Patent Literature

Patent Literature 1: JP 2001-334285 A
Patent document 2: JP 2022-42384 A

### SUMMARY OF INVENTION

### Technical Problem

In the method of controlling the additive amount of nutrient substances based on the TOC concentration measured on-line, there is a problem that clogging occurs inside piping of the on-line TOC concentration meter due to accumulation of suspended solids (SS) and oil contents, formation of a biofilm, etc., and the measured value becomes unstable.

The object of the present invention is to provide a wastewater treatment method and a wastewater treatment apparatus that can stably determine the optimal additive amount of nutrient substances for raw water, which is organic wastewater, in biological treatment of the organic wastewater.

### Solution to Problem

The wastewater treatment method according to an aspect of the present invention is a wastewater treatment method for performing biological treatment on raw water, which is organic wastewater, in a reaction tank, including: a concentration measurement step to measure concentration of at least a volatile organic compound in gas released from water in the reaction tank; and a control step to control an amount of a nutrient substance added to the raw water based on a measured value of the concentration obtained in the concentration measurement step.

The wastewater treatment apparatus according to an aspect of the present invention includes: a reaction tank which performs biological treatment of raw water, which is organic wastewater; an adding means for adding a nutrient substance to the raw water; a concentration measurement means for measuring concentration of at least a volatile organic compound in gas released from water in the reaction tank; and a control means for controlling an additive amount of the nutrient substance by the adding means based on a measured value of the concentration obtained by the concentration measurement means.

When the biological treatment performed in the reaction tank is aerobic treatment, the gas generated from the water in the reaction tank contain carbon dioxide, and by measuring the carbon dioxide concentration, the concentration of organic matter in the raw water can be estimated, and then the additive amount of the nutrient substance can be controlled according to the estimated organic matter concentration. However, when there are fluctuations in the concentration of organic matter, especially when there is a sudden increase in the concentration of organic matter, if the additive amount of nutrient substance is controlled using only the carbon dioxide concentration as an indicator, the additive amount of nutrient substance will be insufficient as a result. According to the knowledge obtained by the present inventors, when the raw water is organic wastewater containing volatile organic compounds or when volatile organic compounds are generated as intermediate metabolites by the biological treatment, if the amount of nutrient substance added is insufficient, these volatile organic compounds accumulate in the reaction tank and the concentration of volatile organic compounds in the gas released from the reaction tank increases. Therefore, in the present invention, by measuring the concentration of volatile organic compounds in the gas generated from the water in the reaction tank and controlling the additive amount of nutrient substance based on the concentration of volatile organic compounds, it is possible to further optimize the additive amount of nutrient substance and to further reduce the emission amount of volatile organic compounds. The control here is, for example, to increase the additive amount of nutrient substance when the concentration of volatile organic compounds increases, and to decrease the additive amount of nutrient substance when the concentration decreases. If the concentration of volatile organic compounds in the gas generated from the water in the reaction tank shows a constant value for some time, the additive amount of nutrient substance can also be adjusted by temporarily decreasing the additive amount of nutrient substance by a certain amount and then checking whether the concentration of volatile organic compounds in the gas increases during that time.

In an aspect of the present invention, the additive amount of nutrient substance may be controlled based only on the concentration of volatile organic compound contained in the gas generated from the water in the reaction tank, or the concentration of volatile organic compound and the concentration of carbon dioxide contained in the gas generated from the water in the reaction tank may be used together to control the amount of nutrient substance added. In case of estimating the concentration of organic matter in the raw water based on the concentration of carbon dioxide contained in the gas generated from the water in the reaction tank, the tracking performance may deteriorate when there are sudden concentration fluctuations, or loading fluctuations, in the raw water, and the amount of nutrient substance added may deviate from the optimal value. In such cases, it is easy to maintain the optimum additive amount of nutrient substance by using both the control by the carbon dioxide concentration and the control by the volatile organic compound concentration. For example, when the concentration of organic substance in the raw water is estimated according to the carbon dioxide concentration to control the amount of nutrient substance added, the amount of nutrient substance added can be made more appropriate by additionally adding the nutrient substance when the concentration of volatile organic compound in the gas generated from the water in the reaction tank increases.

If aeration or air diffusion is performed in the reaction tank, the concentration of volatile organic compounds in the gas generated from the water in the reaction tank may change according to the flow rate of air or other gases supplied to the reaction tank, so the flow rate of the gas supplied to the reaction tank or the gas discharged from the reaction tank may also be measured and the amount of nutrient substance added may be controlled based on both the measured value of the concentration measurement and the measured value of the flow rate. In wastewater treatment by anaerobic microorganisms, i.e., anaerobic treatment, no aeration or the like is performed, but even in that case, the flow rate of the gas generated from the reaction tank may be measured and the additive amount of nutrient substance may be controlled based on both the measured value of the concentration and the measured value of the flow rate.

In the present invention, the volatile organic compounds contained in gas generated from water in the reaction tank may be volatile organic compounds contained in the raw water or volatile organic compounds generated as intermediate metabolites in the biological treatment. Volatile organic compounds covered by the present invention include, for example, alcohols such as methyl alcohol, ethyl alcohol, and isopropyl alcohol; ketones such as acetone; aromatics such as benzene, toluene, and xylene; esters such as ethyl acetate; organic acids such as butyric acid, propionic acid, and acetic acid; as well as organochlorine compounds. Wastewater containing isopropyl alcohol is often discharged from semiconductor device manufacturing plants, etc. When biological treatment of organic wastewater containing isopropyl alcohol is performed, the amount of nutrient substance added can be controlled based on the concentration of isopropyl alcohol in the gas generated from the water in the reaction tank. However, in the biological treatment of isopropyl alcohol, acetone is generated as an intermediate metabolite, and acetone is more volatile than isopropyl alcohol, so it is easier to control the additive amount of nutrient substance based on the concentration of acetone in the gas generated from the water in the reaction tank. When the type of organic matter contained in organic wastewater is known, it is possible to determine the overall concentration of volatile organic compounds without identifying the type of volatile organic compounds contained in the gas generated from the water in the reaction tank and control the amount of nutrient substance added based on that concentration.

Various means can be used to measure the concentration of volatile organic compound in the present invention. For example, manual measurement using a detector tube or on-line measurement using an instrument can be used. The instrumental methods include, for example, a method using a photoionization detector (PID), a method using a hydrogen flame ionization detector (FID), infrared absorption spectroscopy, interference amplified reflectometry (IER) based on swelling of a thin polymer film, a method combining catalytic oxidation and a carbon dioxide sensor, a method using a semiconductor gas sensor, a gas chromatography method, and so on.

In the present invention, the nutrient substance includes a substance necessary for the survival and growth of microorganisms, i.e., nutrient salts such as nitrogen and phosphorus, and trace elements such as iron and manganese. Furthermore, in the present invention, the nutrient substance also includes substances that promote the biological treatment as co-metabolites, although they are not essential for the survival and growth of microorganisms. As an example, when organochlorine compounds such as trichloroethylene, which are also volatile organic compounds, are targeted for the treatment, it is known that the decomposition of the organochlorine compounds by the biological treatment can be promoted by adding methane or phenol as a co-metabolite, and the present invention can be used to optimize the additive amount of such co-metabolites.

### Advantageous Effects of Invention

According to the present invention, it is possible to determine the optimal amount of nutrient substance to be added to raw water, which is organic wastewater, in biological treatment of organic wastewater in a stable manner.

### BRIEF DESCRIPTION OF DRAWINGS

FIG. 1 is a view illustrating a wastewater treatment apparatus according to an embodiment;

FIG. 2 is a view illustrating a wastewater treatment apparatus according to another embodiment;

FIG. 3 is a view illustrating a wastewater treatment apparatus according to yet another embodiment; and

FIG. 4 is a view illustrating a wastewater treatment apparatus according to yet another embodiment.

### DESCRIPTION OF EMBODIMENTS

Next, embodiments according to the present invention will be explained with reference to the drawings.

The present invention relates to a technology for decomposing and removing organic substances in raw water, which is organic wastewater, by biological treatment using microorganisms for the raw water. The organic wastewater to which the present invention applies is not restricted as long as it is applicable to biological treatment, and includes, for example, wastewater from public sewage systems; wastewater discharged from respective factories such as food factories, chemical factories, semiconductor manufacturing factories, liquid crystal manufacturing factories, paper pulp factories, and the like; and wastewater from business places in the fields other than these. Compared to wastewater from public sewage systems, the nutritive substance necessary for maintaining high decomposition activity of microorganisms used for biological treatment is likely to be insufficient in the wastewater from nonpublic factories. In particular, shortage of the nutritive substances is remarkable in the wastewater from chemical factories, semiconductor manufacturing factories, and liquid crystal manufacturing factories. When an external organic source such as methyl alcohol is added to inorganic nitrate wastewater (or inorganic nitrite wastewater) that does not contain organic matter to perform denitrification treatment, the wastewater to which the external organic source is added is also organic wastewater covered by the present invention. Biological treatment in the present invention includes aerobic treatment, anaerobic treatment, denitrification treatment, and so on. These biological treatments are performed by an activated sludge method, a membrane bioreactor (MBR) method, a biological membrane method by a fluidized bed or a fixed bed, a granule method, or the like.

In the wastewater treatment method based on the present invention, to optimize the amount of nutrient substances added to the raw water, the concentration of at least a volatile organic compound in the gas released from the water in the reaction tank is measured, rather than directly measuring the BOD concentration or the TOC concentration of the raw water. Then, based on the measured concentration, the amount of nutrient substances added to the raw water is controlled. In addition to the concentration of volatile organic compound, the carbon dioxide concentration in the gas released from the water in the reaction tank may be measured, and the amount of nutrient substance added to the raw water may be controlled based on the carbon dioxide concentration. Based on the measured value of the carbon dioxide concentration, the concentration of organic matter in the raw water, e.g., the BOD concentration value, can also be calculated. When the organic matter concentration in the raw water is calculated based on the carbon dioxide concentration, control of the additive amount of nutrient substance based on the calculated organic matter concentration can be performed as the primary control, while increasing the additive amount of nutrient substance when there is an increase in the concentration of the volatile organic compound.

When the wastewater treatment is aerobic treatment, aeration or air-diffusion is performed by blowing air or other gases into the reaction tank. If the flow rate of the gas supplied to the reaction tank changes, the concentration may change even if the amount of volatile organic compound and carbon dioxide generated in the reaction tank is the same. Further, the generated amount of volatile organic compound and carbon dioxide in the reaction tank fluctuates according to the flow rate of the gas supplied to the reaction tank, and the concentration may change according to the fluctuation in the generated amount. Even in the case of anaerobic treatment, the flow rate of gas generated from the water in the reaction tank itself may fluctuate. Therefore, in the wastewater treatment method based on the present invention, the flow rate of gas supplied to or released from the reaction tank may be measured. When measuring the flow rate of the gas, the amount of nutrient substance added to the raw water may be controlled based on the measured value of the concentration and the measured value of the flow rate, or the amount of nutrient substance added to the raw water may be controlled based on the value obtained by multiplying the measured value of the concentration and the measured value of the flow rate. Furthermore, the quality of the water, e.g., pH, in the reaction tank may be measured, and the amount of nutrient substance added to the raw water may be controlled based on the measured value of carbon dioxide concentration, the measured value of flow rate, and the measured value of water quality.

If the biological treatment is aerobic treatment, the water in the reaction tank is usually subjected to aeration treatment or air-diffusion treatment by setting up a blower to blow air into the reaction tank, so the flow rate of the gas may be measured as the flow rate of air supplied from the blower into the reaction tank, or the total flow rate of the gases discharged from the reaction tank may be measured. If aerobic treatment is performed using a fluidized bed, a screen is placed in the reaction tank to separate the carriers, and air is also blown in to clean the screen. In this case, the flow rate of the gas may be the sum of the air flow rate from the blower for diffusing air and the air flow rate for screen cleaning. If the biological treatment is anaerobic treatment, the overall flow rate of gas released from the reaction tank may be measured as the gas flow rate.

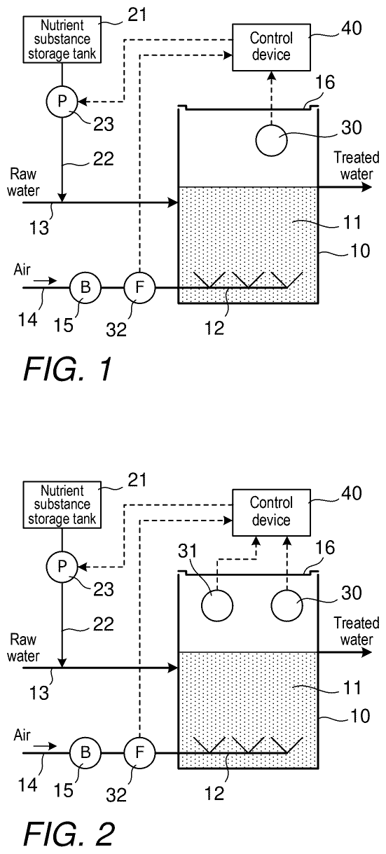

FIG. 1 shows a wastewater treatment apparatus according to an embodiment. The wastewater treatment apparatus shown in FIG. 1 is equipped with fluidized-bed type reaction tank 10 that stores raw water, which is organic wastewater, and performs biological treatment of the raw water under aerobic conditions. The treated water in which organic matter has been decomposed and removed by the biological treatment is discharged from reaction tank 10. Reaction tank 10 is filled with carriers 11, and air diffusing device 12 is provided at the bottom of reaction tank 10 to blow air into reaction tank 10 to supply oxygen, i.e., for aeration. Reaction tank 10 is connected to inlet pipe 13 that supplies the raw water to reaction tank 10. Gas pipe 14 is connected to air diffusing device 12 to supply air to air diffusing device 12, and blower 15 for air delivery is installed in gas pipe 14. Carriers 11 that can be used here include, for example, plastic carriers, sponge-like carriers, gel-like carriers, and so on. Among these, sponge-like carriers are preferred from the viewpoint of cost and durability. An stirring device for stirring carriers 11 may be provided in reaction tank 10.

Nutrient substances are necessary for microorganisms to maintain high decomposition activity and proliferate in the biological treatment, and if the nutrient substances are insufficient in the raw water, they must be added to the raw water in reaction tank 10 or in a stage before reaction tank 10. In the wastewater treatment apparatus according to the present embodiment, nutrient substance storage tank 21 is provided to store nutritious liquid, i.e., solution of nutrient substances, and nutrient substance storage tank 21 is connected to inlet pipe 13 via nutritious liquid pipe 22. Nutrition liquid pipe 22 is equipped with pump 23 for feeding the nutritious liquid. Thus, in this wastewater treatment apparatus, nutrient substances can be added to the raw water that flows through inlet pipe 13 and is supplied to reaction tank 10, and the amount of nutrient substance added to the raw water can be controlled by controlling pump 23. Nutrient substances can be roughly divided into nutrient salts including nitrogen and phosphorus, and trace elements, which are required in smaller quantities than nitrogen and phosphorus. The trace elements include: alkali metals such as sodium, potassium, calcium and magnesium; and metals such as iron, manganese and zinc. Urea and ammonium salts can be used as nitrogen sources. Phosphoric acid and phosphates can be used as phosphorus sources.

In the wastewater treatment apparatus shown in FIG. 1, the amount of nutrient substance added is controlled based on the concentration of a volatile organic compound in the gas released from the water in reaction tank 10 due to the biological treatment. Therefore, reaction tank 10 is equipped with VOC sensor 30 so that it detects the concentration of the volatile organic compound in the gas released from the water in reaction tank 10. Assuming that reaction tank 10 is covered by lid 16, VOC sensor 30 is installed in the gas phase portion in reaction tank 10 or in the piping connected to this gas phase portion, etc. Since VOC sensor 30 must avoid condensation, if it is installed in the piping, the piping may be kept warm and a mist separator may be installed in the position immediately before VOC sensor 30. According to the inventors' findings, even under completely aerobic conditions in which the dissolved oxygen (DO) concentration in the water in reaction tank 10 is 3 mg/L or higher, hydrogen sulfide, which should normally be generated under anaerobic conditions, is generated in reaction tank 10 under high loading conditions in which a BOD volume loading condition is 1.5 kg/m³/day. Corrosive gases such as hydrogen sulfide may corrode VOC sensor 30, so it is necessary to remove the corrosive gases before making measurements with VOC sensor 30. One method of removing hydrogen sulfide is, for example, to bring the gas fed to VOC sensor 30 into contact with iron oxide to remove hydrogen sulfide by fixing it as iron sulfide.

If reaction tank 10 is an open system, to reduce the influence of outside air on the measurement results, the open area at the top of reaction tank 10 can be made as small as possible, tubular piping or the like can be inserted to underneath the water surface, and VOC sensor 30 can be placed at a position above the water surface in that piping. VOC sensor 30 can be selected appropriate for the type of the volatile organic compound to be measured, and one that measures the overall concentration of volatile organic compounds can also be used regardless of the type of the volatile organic compound.

Furthermore, in the wastewater treatment apparatus shown in FIG. 1, at the position between blower 15 and air diffusing device 12, gas pipe 14 is provided with air flow meter 32 to measure the flow rate of the air flowing therein. When the amount of air delivered by blower 15 is constant or when the effect of fluctuations in the flow rate of the diffused air is small, it is not necessary to provide air flow meter 32, but it is preferable to provide air flow meter 32 for more precise control of the additive amount of nutrient substance. Instead of measuring the flow rate of air supplied to reaction tank 10 by installing air flow meter 32 in gas pipe 14, the flow rate of gas released from reaction tank 10 may be measured. In case of measuring the flow rate of gas released from reaction tank 10, when reaction tank 10 is completely covered by lid 16, air flow meter 32 can be installed in the piping that connects to the interior of reaction tank 10 to discharge the gas to the outside. When reaction tank 10 is an open system, in order to reduce the influence of outside air on the measurement results, the open area at the top of reaction tank 10 can be made as small as possible, a tubular pipe or the like can be inserted to below the water surface, and air flow meter 32 can be installed on the pipe.

Next, the control of the amount of nutrient substance added in the wastewater treatment apparatus shown in FIG. 1 will be described. In the present embodiment, by measuring the concentration of volatile organic compound in the gas generated from the water in the reaction tank, and controlling the additive amount of nutrient substance controlled based on the concentration of volatile organic compound, it is possible to further optimize the amount of nutrient substance added and to reduce the emission amount of volatile organic compound. This control, for example, increases the additive amount of nutrient substance when the concentration of volatile organic compound increases, and decreases the additive amount of nutrient substance when the concentration decreases. If the concentration of volatile organic compound in the gas generated from the water in the reaction tank shows a constant value for some time, the amount of nutrient substance added can be adjusted by temporarily decreasing the additive amount of nutrient substance by a certain amount and checking whether the concentration of volatile organic compound in the gas increases during that time.

Since phosphorus and nitrogen in organic wastewater are taken in as nutrient sources for organisms in reaction tank 10, they are added to organic wastewater as nutrient substances such as phosphorus and nitrogen sources in biological treatment in order to promote the growth of microorganisms and thus the decomposition of organic matter. However, as described in Patent Literature 2, if the concentration of soluble phosphorus in the water in reaction tank 10 is high, the amount of surplus sludge generated as a result of the decomposition of organic matter increases. To reduce the amount of surplus sludge generated, it is preferable to maintain the soluble phosphorus concentration in reaction tank 10 in a depleted state, specifically at 0.5 mg/L or lower, and it is more preferable to maintain it at 0.1 mg/L or lower. On the other hand, if the concentration of soluble nitrogen in reaction tank 10 is in a depleted state, the BOD removal rate will decrease significantly. To prevent a significant decrease in the BOD removal rate, the concentration of soluble nitrogen in reaction tank 10 is preferably maintained in a residual state, specifically at 3 mg/L or higher, and more preferably, at 5 mg/L or higher. Therefore, when controlling the additive amount of nutrient substance, control device 40 preferably determine the additive amount of nutrient substance so that the concentration of soluble phosphorus in the water in reaction tank 10 is 0.5 mg/L or less.

FIG. 2 shows a wastewater treatment apparatus according to another embodiment. The wastewater treatment apparatus shown in FIG. 2 is configured such that, in the wastewater treatment apparatus shown in FIG. 1, carbon dioxide concentration sensor 31 that measures the carbon dioxide concentration contained in the gas generated from the water in reaction tank 10 is provided and the measurement results from carbon dioxide concentration sensor 31 are also sent to control device 40. In the present embodiment, the concentration of organic substances in the raw water is estimated based on the carbon dioxide concentration measured by carbon dioxide concentration sensor 31, and the amount of nutrient substance added is controlled based on this estimated value, and the amount of nutrient substance added is further increased or decreased according to the volatile organic substance concentration. As carbon dioxide concentration sensor 31, for example, an optical type, an electrochemical type or a semiconductor type can be used, but it is preferable to use a sensor by a non-dispersive infrared absorption (NDIR) method. The measurement of the carbon dioxide concentration may be performed manually or on-line. Carbon dioxide concentration sensor 31 is installed in reaction tank 10 in the same form as VOC sensor 30. Since carbon dioxide concentration sensor 31 must also avoid condensation and corrosive gases, if it is installed in the piping, a mist separator or a removing device of corrosive gases may be installed at the position immediately before carbon dioxide concentration sensor 31, as well as keeping the piping warm.

When adding nutrient substances (i.e., nutrient salts and trace metals) to the raw water, it is recommended that the amount of nutrient substance added be proportional to the concentration of organic matter, preferably BOD concentration, in the raw water. For example, it is recommended that the additive amount of nitrogen (N) and phosphorus (P) in aerobic treatment is to be BOD:N:P=100:5:1 on a mass basis. In the present embodiment, the BOD of the raw water is not measured by an on-line TOC concentration meter or the like, and instead, the BOD concentration value of the raw water is calculated from the carbon dioxide concentration of the gas released from the water in reaction tank 10, and the additive amount of nutritive substance is determined based on the calculated BOD concentration value. For that purpose in the present embodiment, the concentration of volatile organic compound measured by carbon dioxide concentration sensor 31 is taken as an input value (Xn), the BOD concentration of the raw water corresponding to the input value (Xn) is taken as an output value (Yn). After obtaining a certain number of combinations of the input value and the output value in advance, a model (or a relational expression) is created. The number of combinations to be acquired is, for example, several tens to hundred sets. When the air flow rate is measured by air flow meter 32 in addition to measuring the carbon dioxide concentration, the combination of the carbon dioxide concentration and the measured value of air flow rate may be used as the input value (Xn), or the value obtained by multiplying the measured value of carbon dioxide concentration measurement and the measured value of air flow rate, or the multiplier value, may be used as the input value (Xn).

Once the model has been created, the measured value of the carbon dioxide concentration measured by carbon dioxide sensor 31 is input to the model, or the combination of the measured value of carbon dioxide concentration measured by carbon dioxide sensor 31 and the measured value of air flow rate measured by air flow meter 32 is input to the model, and, based of the resulting BOD concentration value output from the model, pump 23 is driven to control whether or not and how much the nutrient substance is added to the raw water. To perform such control, the wastewater treatment apparatus is equipped with control device 40 that maintains the created model, applies the carbon dioxide concentration value obtained by carbon dioxide sensor 31 and the measured value obtained by air flow meter 32 to the model to calculate the BOD concentration value of the raw water, and controls start and stop of pump 23 and the flow rate based on the BOD concentration value. Although the BOD concentration is used to create the model, the created model itself is considered to one that directly outputs the amount of nutrient material added, using the carbon dioxide concentration as an input, or using the measured value of the carbon dioxide concentration and the measured value of the as inputs.

Once the model is created, the optimal amount of nutrient substance to be added can be determined from the measured value of carbon dioxide concentration or from the measured value of carbon dioxide concentration and the measured value of air flow rate, without explicitly calculating the BOD concentration value. In the second embodiment, after determining the optimal additive amount of nutrient substance based on the measured value of carbon dioxide concentration and controlling the addition of the nutrient substance to the raw water, when the concentration of volatile organic compound measured by VOC sensor 30 increases, the nutrient substance is additionally added to the raw water, and when the concentration of volatile organic compounds that had increased decreases, the additive amount of nutrient substance that has been additionally added to the raw water is reduced. This further optimizes the additive amount of nutrient substance and reduces the emission of volatile organic compounds.

Next, the creation of the model is described. A model that outputs the corresponding BOD concentration of the raw water as an output value when an input value is entered can be created using various types of regression analysis, for example. In particular, if the model is created by supervised learning using neural network technology, the accuracy of controlling the additive amount of nutrient substance is improved. The concentration of volatile organic compound obtained by carbon dioxide sensor 31 can vary depending on the configuration and size of reaction tank 10, the size of the gas phase portion in reaction tank 10, and the type of the biological treatment, etc. The air flow rate of the air supplied to reaction tank 10 for air-diffusing can vary depending on the configuration and size of reaction tank 10. Therefore, the model may be set for each reaction tank 10. Furthermore, since the relationship between the BOD concentration of the raw water and the measured carbon dioxide concentration or air flow rate may vary depending on the type or source of the raw water, a model may be prepared for each type and source of the raw water, and from among the models so prepared, a model used to control the additive amount of nutrient substance may be selected according to the type and source of the raw water.

For controlling the amount of nutrient substance added to the raw water, it is possible to measure the concentration of organic matter in the raw water on-line using an on-line TOC concentration meter, but on-line TOC concentration meters are equipped with narrow piping to draw a small amount of sample water into the measurement device and are prone to clogging, making the measurement values unstable. In contrast, carbon dioxide sensor 31 performs measurements without coming into contact with water, so the stability of measured values is extremely high. The gas flow rate can also be measured stably. Therefore, in the wastewater treatment apparatus according to the present invention, the optimal value of the amount of nutrient substance added to the raw water can be stably determined without directly measuring the concentration of organic matter in the raw water.

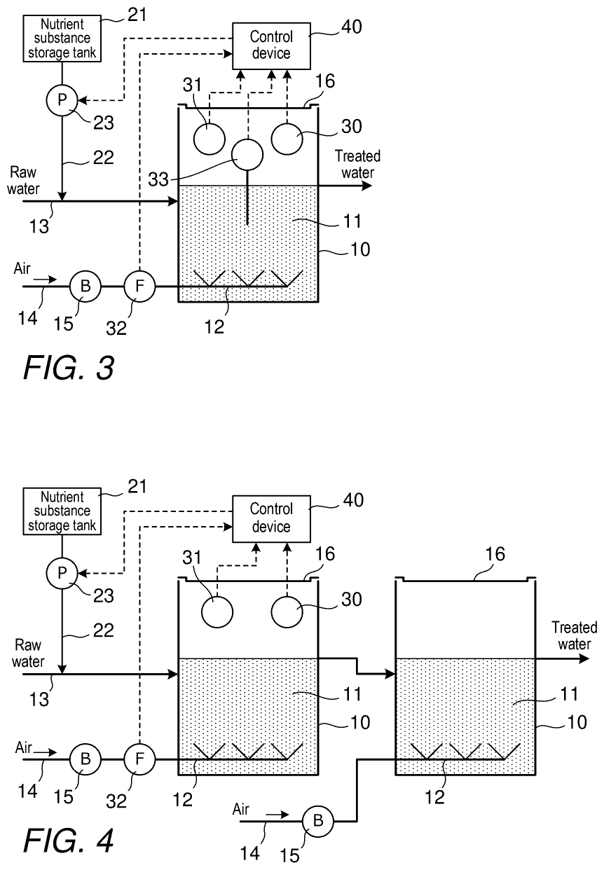

FIG. 3 shows a wastewater treatment apparatus according to yet another embodiment. The wastewater treatment apparatus shown in FIG. 3 is configured such that, in the wastewater treatment device shown in FIG. 2, a water quality measurement unit 33 that measures the water quality of the water in reaction tank 10 is provided, and the measurement results from water quality measurement unit 33 are also sent to control device 40. The water quality items measured by water quality measurement unit 33 include at least pH, and in addition to pH, water temperature and other items may also be measured. The model used in the wastewater treatment apparatus according to the present invention is one in which the combination of the concentration of volatile organic compound, the concentration of carbon dioxide measured by carbon dioxide sensor 31, and the value of water quality (especially pH) measured by water quality measurement unit 33 is taken as an input (Xn), and the BOD concentration of the raw water corresponding to the input value (Xn) is taken as an output value (Yn). The model is created in the same manner as described above. The pH value is preferably used as the water quality value. In addition to the values of the volatile organic compound concentration and the carbon dioxide concentration, and the water quality, the measured value of air flow rate obtained by air flow meter 32 may be combined to obtain the input (Xn), if necessary. Control device 40 applies the carbon dioxide concentration measured by carbon dioxide concentration sensor 31 and the value of water quality (especially pH) measured by water quality measurement unit 33 to the model to calculate the BOD concentration value of the raw water and controls pump 23 based on the BOD concentration value. If necessary, control device 40 may calculate the BOD concentration value of the raw water by applying the value of the air flow rate obtained by air flow meter 32 to the model, in addition to the values of carbon dioxide concentration and water quality. When the concentration of volatile organic compound measured by VOC sensor 30 increases while pump 23 is controlled based on the BOD concentration value, control device 40 controls the pump 23 so that the additive amount of nutrient substance increases, and when the concentration of volatile organic compound that had increased decreases, control device 40 controls pump 23 so that the additive amount of nutrient substance that has additionally added is reduced.

As well known, inorganic carbonic acid in water changes its form as free carbonic acid (CO₂), bicarbonate ion (HCO³⁻), and carbonate ion (CO₃²⁻) depending on pH. Therefore, even if the concentration of organic matter in the raw water is the same, the concentration of carbon dioxide in the gas released from the water in reaction tank 10 may change according to pH. In the wastewater treatment system apparatus in FIG. 2, the pH of the water in reaction tank 10 is also taken into account to control the amount of nutrient substance added, so the additive amount of nutrient substance can be optimized regardless of the pH of the raw water. The solubility of carbon dioxide in water depends on the water temperature, and if the solubility of carbon dioxide changes, the concentration of carbon dioxide in the gas released from the water in reaction tank 10 will also change. Therefore, if there are water temperature fluctuations in reaction tank 10, the water temperature as well as pH can be measured in water quality measurement unit 33, and the amount of nutrient substance added can be controlled based on the water temperature in addition to the concentration of volatile organic compound, the concentration of carbon dioxide, and pH.

In wastewater treatment, a plurality of reaction tanks that perform biological treatment are sometimes connected in series, and the treated water discharged from the reaction tank in the preceding stage is led to the reaction tank in the next stage to perform the biological treatment in each reaction tank, thereby obtaining the treated water in which organic substances are highly removed. FIG. 4 shows a wastewater treatment apparatus which performs wastewater treatment by aerobic biological treatment in the same manner as those shown in FIGS. 1 and 2, and in which a plurality of reaction tanks 10 are provided in series, i.e., in multiple stages. When reaction tanks 10 are installed in multiple stages of two or more stages, it is possible to measure the concentration of volatile organic compound, etc. in the gas released from reaction tank 10 at the frontmost stage, calculate the BOD concentration value of the raw water from the measured value obtained, and control the amount of nutrient substance added to the raw water supplied to that reaction tank based on that BOD concentration value. Thus, in the wastewater treatment apparatus shown in FIG. 4, VOC sensor 30, carbon dioxide concentration sensor 31, and air flow meter 32 are provided only in reaction tank 10 at the frontmost stage, so that the nutritious liquid from nutrient substance storage tank 21 is added to the raw water in inlet pipe 13 connected to reaction tank 10 at the frontmost stage. Control device 40 calculates the BOD concentration value of the raw water from the measured values of carbon dioxide concentration sensor 31 and air flow meter 32, and controls pump 23, which feeds the nutritious liquid, based on the BOD concentration value. Furthermore, control device 40 controls the amount of additionally added nutrient substance based on the measured value of VOC sensor 30, as in the second and third embodiments.

When two or more reaction tanks 10 are installed in series, most of the organic matter is decomposed and removed in reaction tank 10 at the foremost stage, so the organic matter that must be removed in reaction tanks at the second and subsequent stages is reduced. In addition, the nutritive substances is re-eluted by killing and dismantling of the microorganisms proliferated in reaction tank 10 in the frontmost stage. For these reasons, the biological treatment can proceed in reaction tanks at the second and subsequent reaction stages without adding nutrient substances to the water supplied to reaction tanks at the second and subsequent reaction stages, and the overall treatment performance of the wastewater treatment apparatus can be maintained. For this reason, it is not necessary to measure the volatile organic compound concentration, the carbon dioxide concentration, or the air flow rate, for the reaction tanks in the second and subsequent stages.

### EXAMPLES

Next, the present invention will be explained in more detail by means of Examples.

### Test Conditions

First, common test conditions for each of Examples will be described. A one-stage reaction tank shown in FIG. 1, with a volume of 19 L and a lid covering the top portion of the reaction tank, was used for the biological treatment of raw water, which is organic wastewater, by aerobic treatment. Aerobic microorganisms were supported onto sponge carriers made of hydrophobic polyurethane resin, and such sponge carriers were filled into the reaction tank at 30% of the volume of the reaction tank as a bulk volume. The residence time in the reaction tank was set to 8 hours. As the raw water, wastewater containing isopropyl alcohol was used to simulate organic wastewater discharged from a semiconductor manufacturing plant. The BOD concentration in the raw water was about 900 mg/L, the nitrogen (N) concentration in the raw water was 2 mg/L or less, and the phosphorus (P) concentration was 0.1 mg or less. The BOD volume loading for the biological treatment was about 2.8 kg/m³/day, the water temperature was about 20° C., the dissolved oxygen (DO) concentration of the water in the reaction tank was 2 mg/L or higher, and the pH of the water in the reaction tank was 7.0 to 7.5. Air was supplied to the reaction tank at a flow rate of 10 L/min for air-diffusion.

Nitrogen (N), phosphorus (P), and trace metals were added as nutrient substances to the raw water, and the concentration of volatile organic compound in the gas released from the water in reaction tank 10 was measured when the amounts of nitrogen and phosphorus added were varied. Since acetone is produced as an intermediate metabolite in the biological treatment of isopropyl alcohol, the concentration of isopropyl alcohol and the concentration of acetone were measured in the measurement of volatile organic compound concentration. Under any conditions, the isopropyl alcohol concentration was 10 ppm or lower, and almost undetectable. Under the conditions described here, the dissolved phosphorus component in the water in reaction tank 10 is considered to be in the form of phosphoric acid when the water in reaction tank 10 reaches a steady state.

### Example 1

When phosphorus was added to the volume of the raw water in reaction tank 10 with a concentration of 10.6 mg/L and the biological treatment was performed, the acetone concentration in the gas released from the water in reaction tank 10 was 10 ppm. When the water in reaction tank 10 reached a steady state, the phosphoric acid concentration of the water in reaction tank 10, i.e. the treated water, was measured to be 2.5 mg/L as P, as a phosphorous equivalent in phosphoric acid.

### Example 2

When phosphorus was added to the volume of raw water in reaction tank 10 with a concentration of 3.4 mg/L and the biological treatment was performed, the acetone concentration in the gas released from the water in reaction tank 10 was 50 ppm, and the phosphoric acid concentration in the treated water in the steady state was 0.02 mg/L as P.

### Example 3

When phosphorus was added to the volume of raw water in reaction tank 10 with a concentration of 4.5 mg/L and the biological treatment was performed, the acetone concentration in the gas released from the water in reaction tank 10 was 10 ppm. The phosphoric acid concentration in the treated water under the steady state was measured to be 0.02 mg/L as P. In Example 3, it was possible to keep the concentration of volatile organic compound in the gas emitted from the water in reaction tank 10 low without excessive addition of phosphorus and reduce the concentration of soluble phosphorus in the treated water. Table 1 summarizes the relationship between the concentration of phosphorus added to the raw water and the concentration of acetone measured as a volatile organic compound in Examples 1 to 3.

TABLE 1

| Concentration of phosphorous added | Concentration of acetone |
|---|---|
| [mg/L] | [ppm] |
| 10.8 | 10 |
| 4.5 | 10 |
| 3.4 | 50 |

In the biological treatment of isopropyl alcohol, acetone is formed as an intermediate metabolite, and the above results indicate that when the biological treatment is not completed, i.e., the treatment is poor, acetone accumulates in reaction tank 10, and this can be detected as an increase in the concentration of acetone in the gas phase. Since the acetone concentration also decreases when the concentration of phosphorus is increased, it is understood that it is possible to reduce the additive amount of nutrient substance to the minimum necessary, i.e., optimize the additive amount of nutrient substance, by measuring the concentration of volatile organic compound such as acetone released from the water in reaction tank 10, increasing the additive amount of nitrogen and phosphorus when this concentration tends to increase, and decreasing the additive amount when the concentration tends to decrease.

### REFERENCE SIGNS LIST

10 Reaction tank;
11 Carriers;
12 Air diffusing device;
13 Inlet pipe;
14 Gas pipe;
15 Blower;
16 Lid;
21 Nutrient substance storage tank;
22 Nutritious liquid pipe;
23 Pump;
30 VOC sensor;
31 Carbon dioxide concentration sensor;
32 Air flow meter;
33 Water quality measurement unit; and
40 Control device.

1. A wastewater treatment method for performing biological treatment on raw water, which is organic wastewater, in a reaction tank, comprising:
measuring a concentration of at least a volatile organic compound in gas released from water in the reaction tank; and
controlling an amount of a nutrient substance added to the raw water based on a measured value of the concentration obtained during the measuring of the concentration.

2. The wastewater treatment method according to claim 1, wherein, in addition to the concentration of the volatile organic compound, carbon dioxide concentration in the gas released from the water in the reaction tank is also measured during the measuring of the concentration.

3. The wastewater treatment method according to claim 1, further comprising:
measuring a flow rate of gas supplied to or released from the reaction tank,
wherein, during the controlling, the amount of the nutrient substance added to the raw water is controlled using a measured value of the flow rate obtained during the measuring of the flow rate in addition to the measured value of the concentration obtained during the measuring of the concentration.

4. The wastewater treatment method according to claim 1, wherein the volatile organic compound whose concentration is measured during the measuring of the concentration is at least one of a volatile organic compound contained in the raw water and a volatile organic compound produced as an intermediate metabolite in the biological treatment.

5. The wastewater treatment method according to claim 1, wherein a concentration of soluble phosphorus in the reaction tank is maintained at 0.5 mg/L or lower in the biological treatment.

6. The wastewater treatment method according to claim 1, wherein when a plurality of the reaction tanks are installed in series, the concentration measurement is performed for the reaction tank at a foremost stage, and the amount of the nutrient substance which is added to the raw water supplied to the reaction tank at the foremost stage or added to the raw water in the reaction tank at the foremost stage is controlled during the controlling.

7. A wastewater treatment apparatus comprising:
a reaction tank which performs biological treatment of raw water, which is organic wastewater;
an adding device for adding a nutrient substance to the raw water;
a concentration measurement device for measuring a concentration of at least a volatile organic compound in gas released from water in the reaction tank; and
a control device for controlling an additive amount of the nutrient substance by the adding device based on a measured value of the concentration obtained by the concentration measurement device.

8. The wastewater treatment apparatus according to claim 7, wherein the concentration measuring device also measures a concentration of carbon dioxide in the gas released from the water in the reaction tank in addition to the concentration of the volatile organic compound.

9. The wastewater treatment apparatus according to claim 7, wherein the control device performs control so that soluble phosphorus concentration in the reaction tank is maintained at 0.5 mg/L or less.

10. The wastewater treatment apparatus according to claim 7,
wherein a plurality of the reaction tanks are installed in series,
wherein the adding device adds the nutrient substance to the raw water supplied to the reaction tank at a foremost stage or the raw water in the reaction tank at the foremost stage, and
wherein the concentration measuring device is provided for the reaction tank at the foremost stage.

11. The wastewater treatment method according to claim 2, further comprising:
measuring a flow rate of gas supplied to or released from the reaction tank,
wherein, during the controlling, the amount of the nutrient substance added to the raw water is controlled using a measured value of the flow rate obtained during the measuring of the flow rate in addition to the measured value of the concentration obtained during the measuring of the concentration.

12. The wastewater treatment method according to claim 2, wherein the volatile organic compound whose concentration is measured during the measuring of the concentration is at least one of a volatile organic compound contained in the raw water and a volatile organic compound produced as an intermediate metabolite in the biological treatment.

13. The wastewater treatment method according to claim 2, wherein a concentration of soluble phosphorus in the reaction tank is maintained at 0.5 mg/L or lower in the biological treatment.

14. The wastewater treatment method according to claim 2, wherein when a plurality of the reaction tanks are installed in series, the concentration measurement is performed for the reaction tank at a foremost stage, and the amount of the nutrient substance which is added to the raw water supplied to the reaction tank at the foremost stage or added to the raw water in the reaction tank at the foremost stage is controlled during the controlling.

15. The wastewater treatment apparatus according to claim 8, wherein the control device performs control so that soluble phosphorus concentration in the reaction tank is maintained at 0.5 mg/L or less.

16. The wastewater treatment apparatus according to claim 8,
wherein a plurality of the reaction tanks are installed in series,
wherein the adding device adds the nutrient substance to the raw water supplied to the reaction tank at a foremost stage or the raw water in the reaction tank at the foremost stage, and
wherein the concentration measuring device is provided for the reaction tank at the foremost stage.
